(19) United States
(12) Patent Application Publication
(10) Pub. No.: US 2025/0196315 A1
(43) Pub. Date: Jun. 19, 2025

(54) FOLD AWAY BENCH SYSTEM

(71) Applicant: Cory F. Brassard, Lyme, CT (US)

(72) Inventor: Cory F. Brassard, Lyme, CT (US)

(21) Appl. No.: 18/542,800

(22) Filed: Dec. 18, 2023

(51) Int. Cl. B25H 1/04; A47B 3/08; A47B 3/10

(52) U.S. Cl. CPC B25H 1/04; A47B 3/08; A47B 3/10

(57) ABSTRACT

Apparatus for cooperation with an associated motor vehicle having a cargo carrying compartment which includes a first rectangular frame having first and second extremities and having a first length dimension intermediate said first and second extremities. The first and second leg support structures respectively support the first rectangular frame at the first and second extremities of the first rectangular frame. Second and third rectangular frames are respectively hinged to the first and second extremities whereby the length of the collective assembly is increased. The sum of the respective lengths of said second and third rectangular frames no more than the first length dimension whereby each of the second and third rectangular frames can be folded into a substantially mutually coplanar relationship substantially parallel to the first rectangular frame.

### TECHNICAL FIELD

The present invention is generally directed to accessories for motor vehicles. More particularly, the present invention is directed to a seating apparatus intended to be deployed when the vehicle is parked, for example at a movie, a picnic, a scenic vista or a sporting event. The apparatus is typically most adapted for use with any hatchback vehicle, sport utility vehicle or sport utility wagon as well as any sedan with an adequate trunk space. The present apparatus utilizes a tubular framework

### BACKGROUND OF THE INVENTION

Prior art free standing chairs seating includes, for example, U.S. Pat. No. 9,128,282 Daniel R. Grace Mar. 15, 2016; US patent 654732 Leslie G. Ammann, Jr. Apr. 15, 2003; U.S. patent Ser. No. 10/332,108 Emil Lehman Jul. 23, 1912; US patent application 20090039685 Jeff Zernov Sep. 4, 2008. These documents are incorporated by reference.

Many individuals carry a plurality of folding chairs in their motor vehicle for use when parked at a scenic location, sporting event or other spot. Typically, if multiple folding chairs are required the folding chairs will collectively take up a substantial part of the available storage space in a given motor vehicle. Often this causes the user to remove the folding chairs from the storage space on the given motor vehicle. Thereafter, when the vehicle spontaneously makes a stop at a given event, the folding chairs are not available.

To minimize a user being confronted by the need for a suitable seating for a plurality of individuals when free standing seats have been removed, it is highly desirable to provide a compact assembly that is much less likely to be displaced from the storage area of the vehicle to accommodate other cargo. It is also an object of the invention to provide seating that can be deployed readily to provide comfortable seating for a plurality of individuals.

### SUMMARY OF THE INVENTION

The shortcomings of the prior art are overcome and additional advantages are provided through apparatus for cooperation with an associated motor vehicle having a cargo carrying compartment which includes a first rectangular frame having first and second extremities and having a first length dimension intermediate said first and second extremities. The first and second leg support structures respectively support the first rectangular frame at the first and second extremities of the first rectangular frame whereby the collective length of the seating is increased.

Second and third rectangular frames are respectively hinged to the first and second extremities whereby the length of the collective assembly is increased. The sum of the respective lengths of said second and third rectangular frames being no more than the first length dimension whereby each of the second and third rectangular frames can be folded into a substantially mutually coplanar relationship substantially parallel to the first rectangular frame.

Each of the frames has a flexible material spanning the framework thereof. The apparatus includes a fabric flap extending from the first rectangular member and having a length sufficient to extend from the first rectangular frame positioned behind an associated motor vehicle to the interior of the cargo area of an associated motor vehicle.

In some forms of the invention, the flexible material spanning the respective frameworks is selected from the group consisting of oxford cloth and canvas. The second and third rectangular frames may include a hinged leg for supporting each of said second and third rectangular frames. Each of these legs may be U-shaped. Similarly, the first and second leg supports may be respective U-shaped legs.

Some embodiments may have a dimension of each rectangular frame measured in a direction perpendicular to the length thereof is the same.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is an isometric view of one form of the folding bench collapsed and stored, for example, on the floor of an associated motor vehicle MV.

FIG. 2 is a side view illustrating an initial step in the process of deploying the folding bench where each of the first and second spaced apart legs are unfolded to a vertical mutually parallel position with the apparatus disposed on the floor of an associated motor vehicle.

FIG. 3 is a side view illustrating the folding bench illustrated in FIG. 2 inverted with the first and second legs now resting on the terrain typically right behind an associated motor vehicle and facilitating unfolding each of t third and fourth legs to a vertical parallel position.

FIG. 4 is a partly schematic view, illustrating the framework construction incorporated in some preferred embodiments of the present invention as well as typical hinge points and typical locking mechanisms to prevent undesired folding of respective elements as well as canvas seating attached to the framework.

FIG. 5 is a fragmentary view illustrating of a typical locking assembly used throughout the folding bench to lock each leg in the deployed position and to prevent inadvertent folding of each leg. Each locking assembly includes first and second pivotally connected arms. A rod couples the respective pivot points of each of two locking assemblies to a user to manually release two locking assemblies.

FIG. 6 is an isometric view of one form of the folding bench deployed directly behind an associated vehicle and illustrating a canvas flap fixed to the bench and extending into the interior of the associated motor vehicle where it is secured by a hook and eye fastener.

FIG. 7 is a fragmentary view of another form of the folding bench in which three parallel bands instead of a single flap extend between the associated vehicle and the folding bench.

FIG. 8 is another view illustrating an alternative connection between a folding bench ands the interior of an associated motor vehicle

FIG. 9 is an isometric view illustrating the folding bench deployed behind an associated motor vehicle.

### DETAILED DESCRIPTION

The apparatus in accordance with the present invention is intended for easy installation within a vehicle, periodically deployed for use as well as easy removal in the event that the user need additional cargo space. Although the apparatus may be installed each time a use is anticipated, the compact construction facilitates installation and continued installation for at least weeks. In such continued installation, the fold away bench will remain connected to the associated vehicle. Particular uses for the apparatus may arise at picnics, watching sports events or movies or even visiting scenic locations. The frequency of use will be dependent upon the individual user's habits as well as the seasonal climatic variations at the place of use. Thus, in warmer climates use will be the more frequent and over a greater part of the calendar year than for users in colder climates. The utilization of Velcro® hook and eye type fasteners to secure the apparatus to the associated vehicle allows easy removal in the event that the vehicle additional cargo space is needed.

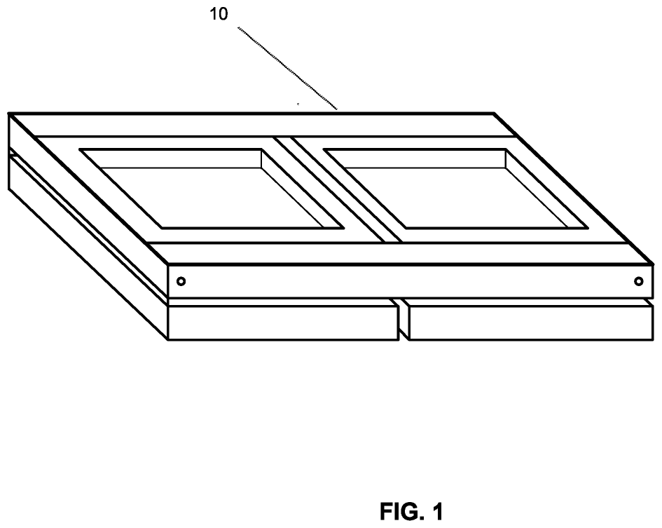

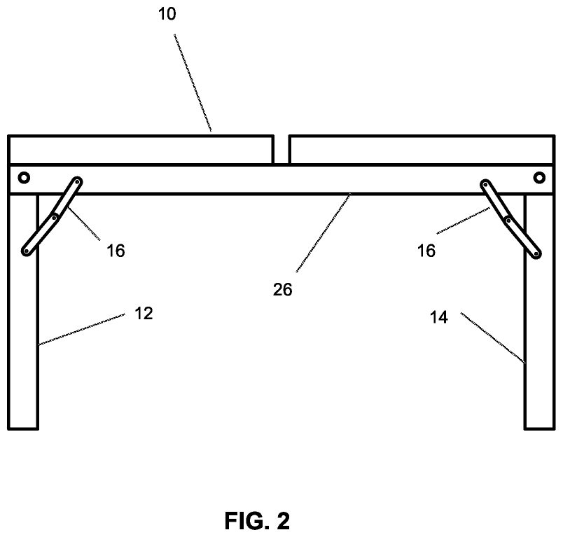

As shown in FIG. 1 one form of the folding bench 10 is shown collapsed and stored, for example, on the floor of an associated motor vehicle MV. Deployment is initiated as shown in FIG. 2 in a side view illustrating first and second spaced apart legs 12, 14 unfolded to a vertical mutually parallel position with the apparatus disposed on the floor of an associated motor vehicle. Each of the legs 12, 14 is secured with a locking assembly 16 to prevent inadvertent leg folding. In some embodiments of the present invention each leg 12, for example, may be U-shaped with two elongated parallel parts hinged to the frame 26 at spaced points and a center part touching the floor or ground. Similarly, some embodiments of the present invention each leg 14, for example, may be U-shaped with two elongated parallel parts hinged to the frame 26 at spaced points and a center part touching the floor or ground.

In other embodiments the “leg 12” may be constructed as two discrete parallel legs spaced apart and individually hinged to the frame 26 with individual locking assemblies 16. Similarly, In other embodiments the “leg 14” may be constructed as two discrete parallel legs spaced apart and individually hinged to the frame 26 with individual locking assemblies 16.

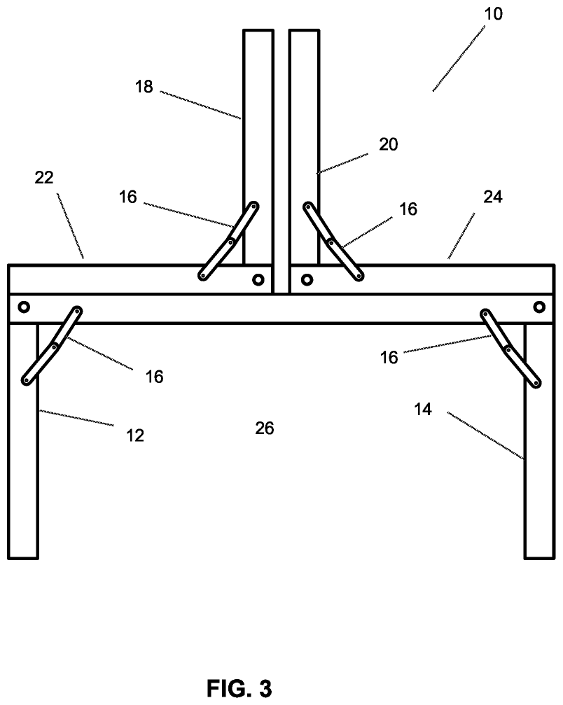

FIG. 3 illustrates the folding bench 10 inverted with the first and second legs 12, 14 now resting on the terrain typically right behind an associated motor vehicle MV. This position facilitates unfolding each of third and fourth legs 18, 20 to a vertical mutually parallel position as well as being mutually parallel to as well as legs 12, 14.

In some embodiments of the present invention each leg 18, for example, may be U-shaped with two elongated parallel parts hinged to the frame 26 at spaced points and a center part touching the floor or ground. Similarly, some embodiments of the present invention each leg 20, for example, may be U-shaped with two elongated parallel parts hinged to the frame 26 at spaced points and a center part touching the floor or ground.

In other embodiments the “leg 18” may be constructed as two discrete parallel legs spaced apart and individually hinged to the frame 26 with individual locking assemblies 16. Similarly, in other embodiments the “leg 20” may be constructed as two discrete parallel legs spaced apart and individually hinged to the frame 26 with individual locking assemblies 16.

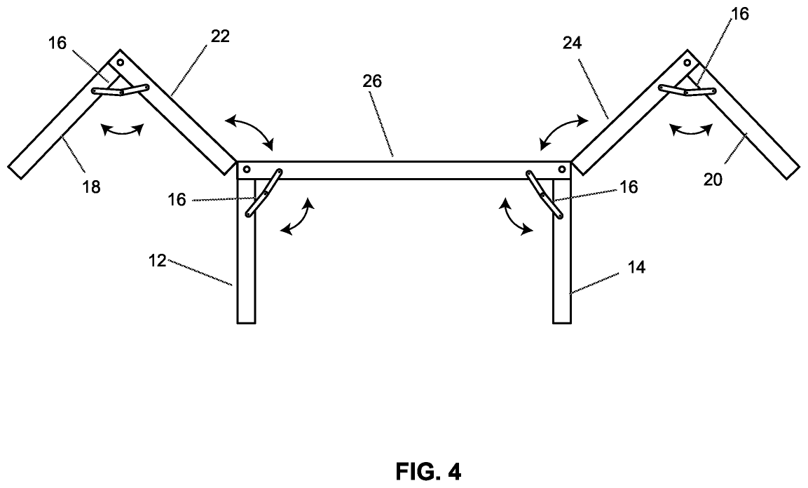

FIG. 4 is a partly schematic view, illustrating further unfolding as well as hinge points to provide additional seating on the terrain behind the associated vehicle MV. More specifically, respective side benches 22, 24 are unfolded from a central bench 26. Thus, the central bench is positioned between respective side benches 22, 24 after deployment. Each of the benches 22, 25, and 24 are constructed as a metal framework supporting a canvas or other flexible sheet seating. The somewhat schematic drawings will be understood to represent that type of construction which inherently is more comfortable for seating, easier to move because it weighs less and is less expensive to manufacture.

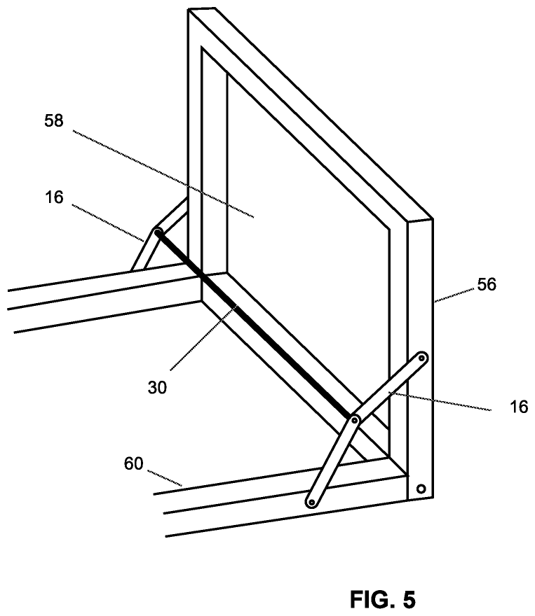

FIG. 5 is a fragmentary view of a typical frame 56 hinged to a typical leg 60 that is secured by a locking assembly 16 used in the folding bench 10 to lock each leg in the deployed position and to prevent inadvertent folding of each leg. A rod 30 connects the respective pivot points of each of two locking assemblies 16 to facilitate a user manually releasing two locking assemblies 16 on respective parallel legs. A piece of flexible sheet material 58 such as canvas, or similar sheet material is secured to the frame 56 to provide, for example, a seating surface. The material attached to the frame for the seat of a lawn chair can vary, but some common options include (1) Nylon: Durable and weather-resistant, nylon is a popular choice for lawn chair seats. It is also easy to clean and dries quickly; (2) Polyester: Another durable and weather-resistant material, polyester is often used for outdoor furniture due to its resistance to fading and mildew; (3)Vinyl: Vinyl is a waterproof and easy-to-clean material that is often used for outdoor furniture, including lawn chair seats or (4) Textilene®: This is a mesh fabric made of polyester with PVC coating, known for its durability, UV resistance, and breathability.

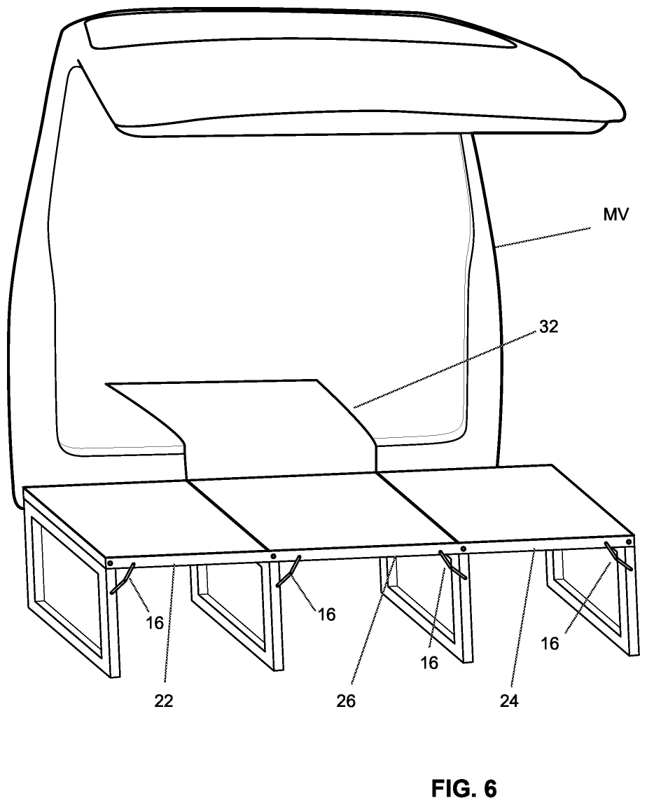

FIG. 6 is an isometric view of one form of the folding bench deployed directly behind an associated vehicle with a canvas flap 32 fixed to the bench 10 and extending into the interior of the associated motor vehicle MV where it is secured by a hook and eye fastener.

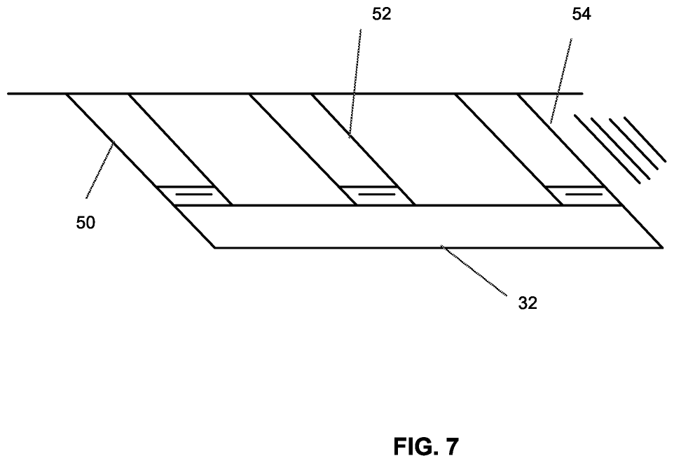

FIG. 7 is a fragmentary schematic view of another form of the attachment of the flap 32 of folding bench 10 in which three parallel bands 50, 52 54, instead of a single flap, extend between the associated vehicle MV and the folding bench 10.

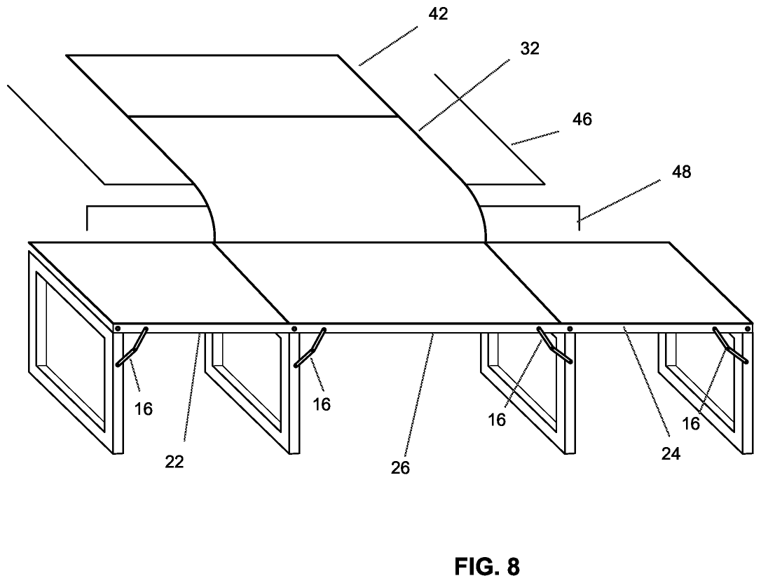

FIG. 8 is another view illustrating a hook section 42 of the flap 32 that extends from the folding bench 10 into the interior of an associated motor vehicle MV. The numeral 46 identifies a schematic representation of alternatively carpeting in the interior of the motor vehicle or a sheet of eye fasteners which cooperate with the hook section 42 of the flap 32 to secure the folding bench 10 to the associated motor vehicle MV. A schematic representation of the rear bumper of the motor vehicle MV is identified by the numeral 48.

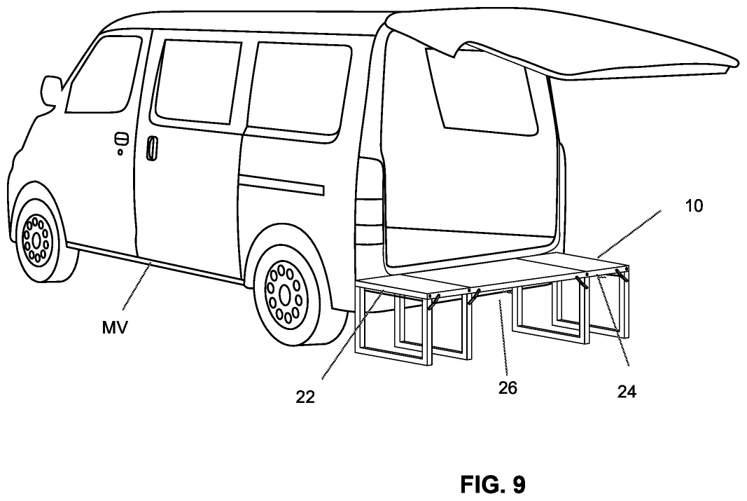

FIG. 9 is an isometric view illustrating the folding bench 10 deployed behind an associated motor vehicle MV.

The anchoring system is an integral part of the bench structure. The folding bench apparatus stores neatly and fully assembled. At the time of deployment, the first two legs which are situated in the top surface of the stored bench, are lifted and locked into place. A typical locking assembly 16 provides a locking function—A rod connecting both pivot points of each leg provides a manner of unlocking the flex points and folding the legs into the stored position. Alternative locking arrangements are readily found, for example on Amazon.com by searching for folding table legs or folding table leg brace. After the legs are locked in the deployed position, the entire assembly is inverted and positioned on the ground is positioned on the ground behind the associated vehicle. A second set of legs is now deployed and locked into place. The bench “extensions” are now folded outward on the left and right sides of the main bench surface. Simple hinge points provide this fold out function. This process is reversed for returning the bench system back to stored position. The length of the fully deployed system is 64 inches—Height—16 inches—these dimensions are subject to change. All metal framework and legs in one embodiment of the present are made of square tubing of industry standard gauge. All cloth or canvas surfaces are fabricated with industrial standard materials for outdoor use.

In one embodiment of the present invention the bench system apparatus is secured to the carpeted floor of the associated motor vehicle utilizing a Velcro® type fastener sheet of hooks permanently secured to the surface of a flap of the bench system. It will be understood that Velcro® fasteners, also known as hook and eye fasteners, typically utilize a sheet of hooks and a cooperating sheet of eyes. The dimensions of a single strip in one embodiment of the invention may, for example, be 30×6 inches. The placement of the strip is dependent on the height of the vehicle above the ground. Alternatively, multiple strips will anchor either a number of straps or a single piece of industry standard outdoor use canvas material. The mounting of the system will allow easy non destructive removability with either clips or some other method of disconnect.

Embodiments of the present invention may use a fabric to span a tubular metal framework. Oxford cloth is a new type of fabric with various functions and wide applications. At present, the main products on the market include: lattice, full-stretch, nylon, and tige. Oxford cloth is also called Oxford spinning. It uses polyester polyester-cotton blended yarn and cotton yarn to interweave.

Canvas (canvas) is a thicker cotton or linen fabric. Named because it was originally used for sails. Generally, plain weave is used, and a small amount of twill weave is used. Multi-strand yarn is used for warp and weft. Canvas are usually divided into two categories: coarse canvas and fine canvas. Coarse canvas, also known as canopy cloth, has good waterproof performance and is used for automobile transportation and open-air warehouse cover and tents in the field.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. Apparatus for cooperation with an associated motor vehicle having a cargo carrying compartment which comprises:
a first rectangular frame having first and second extremities and having a first length dimension intermediate said first and second extremities;
first and second leg support structures respectively supporting said first rectangular frame at said first and second extremities of said first rectangular frame;
second and third rectangular frames being respectively hinged to said first and second extremities whereby the length of the collective assembly is increased;
the sum of the respective lengths of said second and third rectangular frames being no more than said first length dimension whereby each said second and third rectangular frames can be folded into a substantially mutually coplanar relationship substantially parallel to said first rectangular frame;
each of said frames having a flexible material spanning the framework thereof;
said apparatus including a fabric flap extending from said first rectangular member and having a length sufficient to extend from said first rectangular frame positioned behind an associated motor vehicle to the interior of the cargo area of an associated motor vehicle.

2. The apparatus as described in claim 1 wherein said flexible material spanning the respective frameworks is selected from the group consisting of oxford cloth and canvas.

3. The apparatus as described in claim 1 wherein each of said second and third rectangular frames includes a hinged leg for supporting each of said second and third rectangular frames.

4. The apparatus as described in claim 3 wherein each of said legs is U-shaped.

5. The apparatus as described in claim 1 wherein said first and second leg supports are respective U-shaped legs.

6. The apparatus as described in claim 1 wherein the dimension of each rectangular frame measured in a direction perpendicular to the length is the same.
